(19) United States
(12) Patent Application Publication
(10) Pub. No.: US 2022/0402053 A1
(43) Pub. Date: Dec. 22, 2022

(54) HACKSAW BLADE WITH TENSION FOCUSING SLOTS

(71) Applicant: Apex Brands, Inc., Apex, NC (US)

(72) Inventors: Noah Steen, Apex, NC (US); Andrew Speciale, Raleigh, NC (US); Michael Dunigan, Apex, NC (US); Jeromy Higgins, Fishers, IN (US); Matthew Poppe, Raleigh, NC (US)

(21) Appl. No.: 17/843,127

(22) Filed: Jun. 17, 2022

Related U.S. Application Data
(60) Provisional application No. 63/212,328, filed on Jun. 18, 2021.

(51) Int. Cl. B23D 61/12; B23D 49/12; B23D 51/14

(52) U.S. Cl. CPC B23D 61/123; B23D 49/12; B23D 51/14

(57) ABSTRACT

A hacksaw blade may include a first end having a first mounting orifice, a second end having a second mounting orifice, a first side face extending from the first end to the second end, and a second side face, opposite the first side face and extending from the first end to the second end. The blade may further include a top edge extending from the first end to the second end between the first and second side faces, a cutting edge disposed opposite the top edge and including cutting teeth disposed thereon, and a tension focusing slot disposed between the first end and the second end, and spaced apart from each of the top edge and the cutting edge. The slot may be formed by material removal from at least the first side face.

### CROSS REFERENCE

This application claims benefit to U.S. provisional application No. 63/212,328 filed on Jun. 18, 2021, the entire contents of which are hereby incorporated by reference.

### TECHNICAL FIELD

Example embodiments generally relate to cutting devices, and more particularly relate to a blade for a hacksaw that is designed to focus tension proximate to the cutting teeth or cutting edge of the blade.

### BACKGROUND

Hacksaws are useful tools for cutting various types of media including metal. Although some hacksaws are powered, most are hand operated, and most also include a blade that is mounted via mounting holes that pass through opposite longitudinal ends of the blades. A C-shaped frame extends forward from a handle such that opposing ends of the C-shaped frame engage the mounting holes with pins or other mounting apparatuses that pass through the mounting holes. The hacksaw often includes (e.g., at an of the C-shaped frame that is opposite the handle) a tensioning mechanism that pulls one of the pins to increase tension on the blade by stretching the blade between the mounting holes.

In many cases, the blade has cutting teeth on one edge thereof. The handle is used to pass the blade, and consequently also the teeth, over the medium that is being cut. The teeth are often oriented so that cutting occurs mainly in the pull or push stroke. The teeth on different blades can have different degrees of prominence to change the cutting characteristics of the blade (e.g., for different media, or for different desirable cutting characteristics. The blade may be used until the teeth are worn out, or a different cutting characteristic is desired. Then, the pins may be removed, and the old blade may be replaced with a new blade.

An example of such a blade 100 is shown in FIG. 1. As shown in FIG. 1, the blade 100 includes a cutting edge 110 on which a plurality of teeth are disposed. The blade 100 also has a first end 120 and a second end 122 in which a first mounting hole 130 and a second mounting hole 132, respectively, may be disposed. The cutting teeth may extend along all or almost all of the cutting edge 110 in some cases.

The blade 100 may also include a top edge 140, which may be disposed opposite the cutting edge 110. Side faces may be disposed opposite each other extending between lateral edges of the cutting edge 110 and the top edge 140. A longitudinal centerline 150 of the blade 100 typically extends between centers of the first and second mounting holes 130 and 132.

In a typical situation, tension is applied (as noted above) to the blade 100 by exerting a pulling force to separate the first and second mounting holes 130 and 132. When such tension is applied, the cutting edge 110 stays relatively taut, and the cutting edge 110 may effectively be used to cut media. However, over time, the teeth wear out, and the cutting edge 110 can also tend to lose its initial quality of straightness, and begin to waver along its length. This can reduce cutting effectiveness, and lead to the blade 100 wobbling or jumping during a cut.

Accordingly, it may be desirable to improve device designs in order to provide a more robust and longer lasting blade, with improved cutting characteristics over its lifetime.

### BRIEF SUMMARY OF SOME EXAMPLES

Some example embodiments may enable the provision of an improved hacksaw blade. The blade may include a first end having a first mounting orifice, a second end having a second mounting orifice, a first side face extending from the first end to the second end, and a second side face, opposite the first side face and extending from the first end to the second end. The blade may further include a top edge extending from the first end to the second end between the first and second side faces, a cutting edge disposed opposite the top edge and including cutting teeth disposed thereon, and a tension focusing slot disposed between the first end and the second end, and spaced apart from each of the top edge and the cutting edge. The slot may be formed by material removal from at least the first side face.

In another example embodiment, a method of making a blade for a hacksaw may be provided. The method may include cutting or stamping a metal blank to define a blade body extending from a first end to a second end and having a first side face, a second side face, a top edge and a cutting edge. The method may further include punching a first mounting orifice at the first end and a second mounting orifice at the second end from the first side face to the second side face. The method may further include removing material from the first side face or the second side face to define a tension focusing slot disposed between the first end and the second end, and spaced apart from each of the top edge and the cutting edge, and milling teeth on the cutting edge.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 is a side view of a conventional blade;

FIG. 2 is a side view of a blade having a tension focusing slot in accordance with an example embodiment;

FIG. 3 is a side view of a blade having multiple tension focusing slots in accordance with an example embodiment;

FIG. 4 is a perspective view of a portion of the blade of FIG. 3 in accordance with an example embodiment;

FIG. 5 is a cross section view of the blade of FIG. 4 taken along line A-A′ in accordance with an example embodiment;

FIG. 6 is a cross section view of the blade of FIG. 4 taken along line A-A′ in accordance with another example embodiment;

FIG. 7 is a cross section view of the blade of FIG. 4 taken along line A-A′ in accordance with yet another example embodiment; and

FIG. 8 is a block diagram of a method of forming a hacksaw blade in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

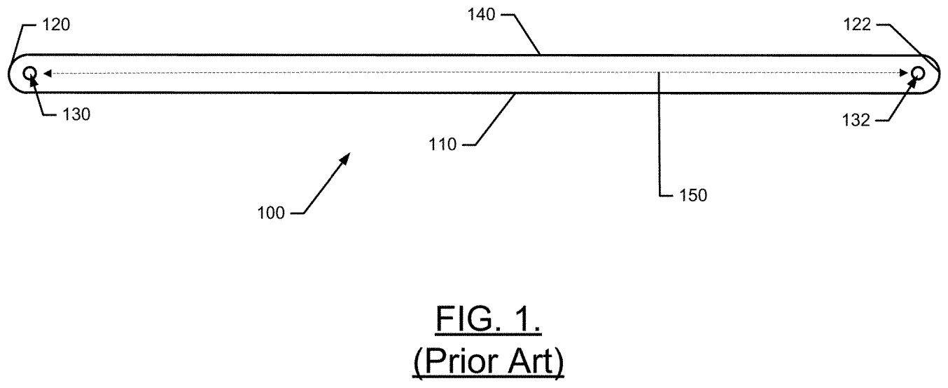

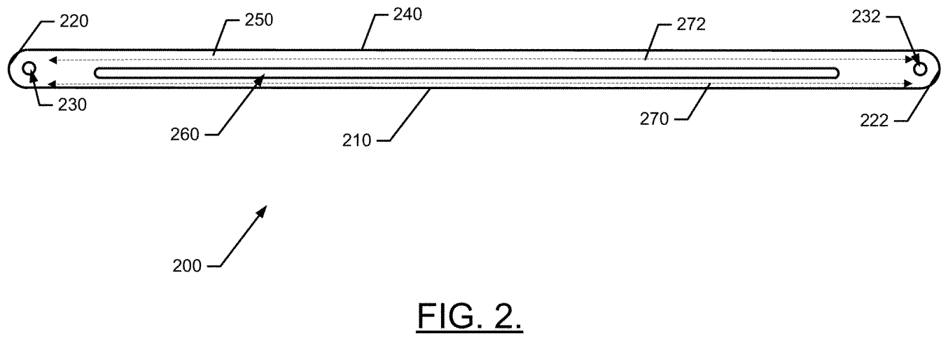

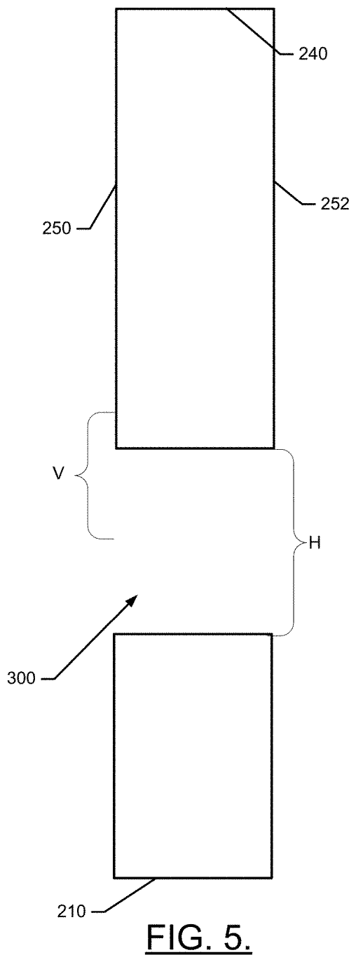

Some example embodiments may relate to the provision of an improved blade for a hacksaw. In this regard, FIG. 2 illustrates a blade 200 in accordance with an example embodiment. The blade 200 includes a cutting edge 210 on which a plurality of teeth are disposed. The blade 200 also has a first end 220 and a second end 222 in which a first mounting hole 230 (or orifice) and a second mounting hole 232 (or orifice), respectively, may be disposed. The cutting teeth may extend along all or almost all of the cutting edge 210 in some cases. The blade 200 may also include a top edge 240, which is disposed opposite the cutting edge 210. Side faces (e.g., a first side face 250 and a second sided face 252 (see FIG. 5) may be disposed opposite each other extending between lateral edges of the cutting edge 210 and the top edge 240. In these respects, the blade 200 is similar to the blade 100 described above in reference to FIG. 1.

However, unlike the blade 100 of FIG. 1, the blade 200 of FIG. 2 includes a tension focusing slot (i.e., slot 260) disposed in the first side face 250. The slot 260 is formed by removing material from the first side face 250. The slot 260 of this example is a single continuous slot, but could be discontinuous in other examples. The slot 260 of this example is disposed in the first side face 250 such that the longitudinal centerline of the blade 200 passes through at least a portion of the slot 260. Moreover, in this example, the slot 260 is cut closer to the cutting edge 210 than the top edge 240. In other words, the longitudinal centerline of the slot 260 is closer to the cutting edge 210 than to the top edge 240, and the longitudinal centerline of the slot 260 is not aligned with the longitudinal centerline of the blade 200.

The existence of the slot 260 at all, when the slot 260 is cut to extend over the longitudinal centerline of the blade 200, causes tension for tightening the blade 200 (or simply maintaining the blade 200 taut) to be transmitted through metal that is above the slot 260 and below the slot 260 (instead of simply through metal along the longitudinal centerline of the blade 200, which is the case for the blade 100 of FIG. 1). In this regard, a first max tension line 270 is shown to extend through metal below the slot 260 (i.e., closer to the cutting edge 210) and a second max tension line 272 is shown to extend through metal above the slot 260. The first max tension line 270 is disposed about half way between the bottom of the slot 260 and the cutting edge 210, and the second max tension line 272 is disposed about half way between the top of the slot 260 and the top edge 240. However, such max tension lines may instead run closer to the slot 260 in some cases. This design improves a situation noticed by the inventors in that wavering of a blade (e.g., blade 100 of FIG. 1) does not extend to the middle of the blade 100 (i.e., along the longitudinal centerline 150). This is due to the fact that tension extending through the blade 100 is greatest along the longitudinal centerline 150, and least at the edges such as the cutting edge 110. By employing the slot 260, the higher tension is moved away from the longitudinal centerline 150, which actually improves tension near the cutting edge 210.

Regardless of the specific location, the first max tension line 270 is nevertheless far closer to the cutting edge 210 than would otherwise be the case in the absence of the slot 260. In this regard, the first max tension line 270 is moved closer to the cutting edge 210, and therefore tends to focus force on the cutting edge 210. The removal of material from the first side face 250 causes a decrease in surface area on the first side face 250 and creates more bias toward the cutting teeth disposed at the cutting edge 210 as the blade is tensioned. By putting more force on the cutting edge 210 (i.e., on the bottom of the blade 200), where the cutting takes place, the blade 200 may tend to cut better and stay straighter for a longer period of time. This may extend the useful life of the blade 200 by extending the length of time that the blade 200 cuts to satisfaction before replacement is deemed necessary.

The slot 260 of FIG. 2 extends over a majority of the length of the blade 200. However, any length of slot 260 could be used in alternative embodiments since any hole or slot formed in any central portion of the length of the blade 200 will cause focusing of forces nearer the cutting edge 210. For a typical blade having a length measured from the first end 220 to the second end 222, the length may be between about 250 mm to about 300 mm. However, example embodiments may be longer or shorter in some cases. Atypical blade may also have a thickness of about 0.6 mm (e.g., from 0.4 mm to about 1 mm) and a height (from the cutting edge 210 to the top edge 240) of about 13 mm (e.g., from about 8 mm to about 20 mm).

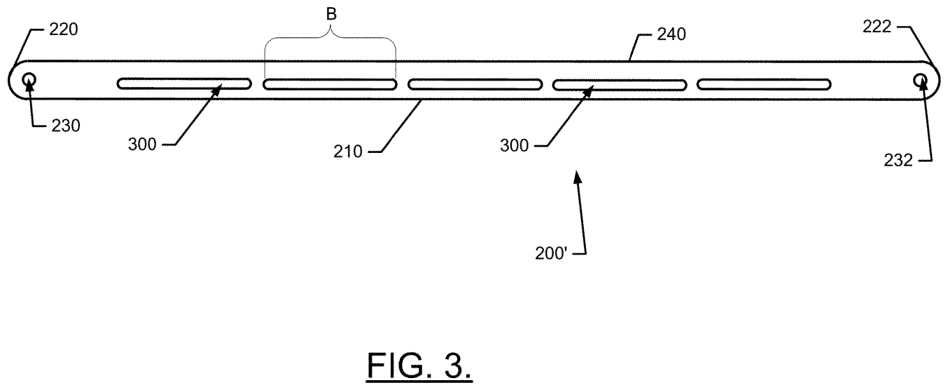

Although FIG. 2 shows an example in which a single and continuous removal of material from the first side face 250 is used to form the slot 260, multiple and discontinuous removals may be used in alternative embodiments. In this regard, FIG. 3 illustrates an example in which a blade 200′ instead has a series of slots 300 that extend in line with each other. Notably, blade 200′ is the same as blade 200 of FIG. 2 except that blade 200′ includes multiple slots 300 instead of the single slot 260 of FIG. 2. The slots 300 of FIG. 3 combine to extend as long as the slot 260 of FIG. 2. However, as noted above, the slots 300 could extend either shorter or longer. In an example embodiment, there could be anywhere between one and fifty slots 300 along the length of the blade 200. Thus, the slots 300 could have a length that extends over any range of lengths from 5% to 95% of the full length of the blade 200′ (i.e., measured from the first end 220 to the second end 222).

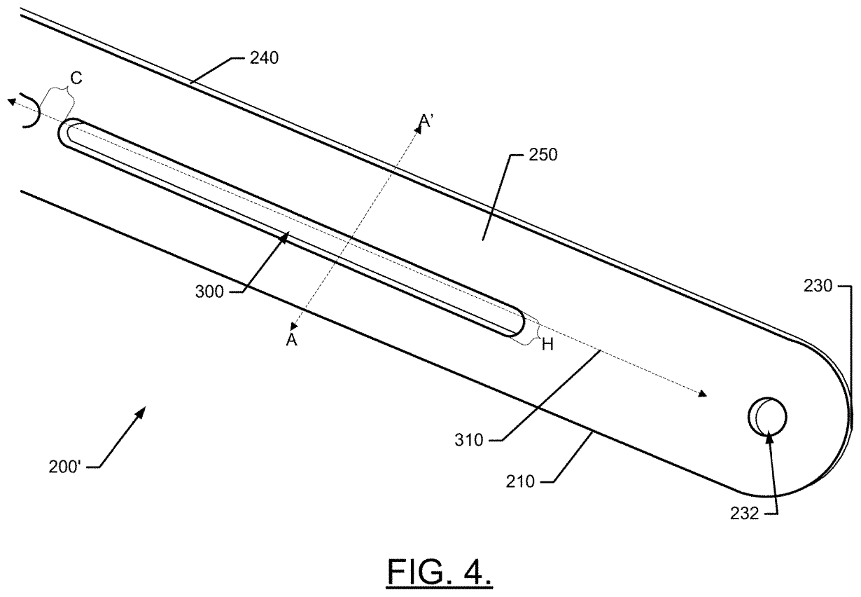

FIG. 4 shows a perspective view of the blade 200′ to show various dimensional characteristics in accordance with an example embodiment. FIGS. 5-7 show different alternative cross section views taken along line A-A′ of FIG. 4 according to respective different example embodiments. As shown in FIGS. 3 and 4, in an example embodiment, each of the slots 300 may have a length (B) in a range of about 0.5 mm to about 100 mm. In the example of FIGS. 3 and 4, the slots 300 may have a length (B) of about 40 mm. A distance (C) between slots 300 may range from about 0.5 mm to about 200 mm. In the example of FIGS. 3 and 4, the distance (C) may be about 8 mm. A height (H) of each slot 300 may range from about 0.5 mm to about 5 mm, which is about 3% to about 40% of a height of the blade measured between the cutting edge 210 and the top edge 240. A vertical position (V) (see FIG. 5) of the slots 300 (i.e., measured relative to the longitudinal centerline 310) may range from about −5 mm to about 5 mm. In other words, a longitudinal centerline of the slot 300 may be positioned in a range from about 5 mm below to about 5 mm above the longitudinal centerline 310 of the blade 200′.

Although multiple slots 300 are not required, the spacing apart of multiple slots 300 may provide an improvement of rigidity of the blade 200′ in some cases. In this regard, for example, the material that extends between slots 300 may prevent the cutting edge 210 from having too much freedom of movement relative to the top edge 240. Forming the slots 300 by embossing instead of performing a through cut may also increase rigidity of the blade 200′ in this regard.

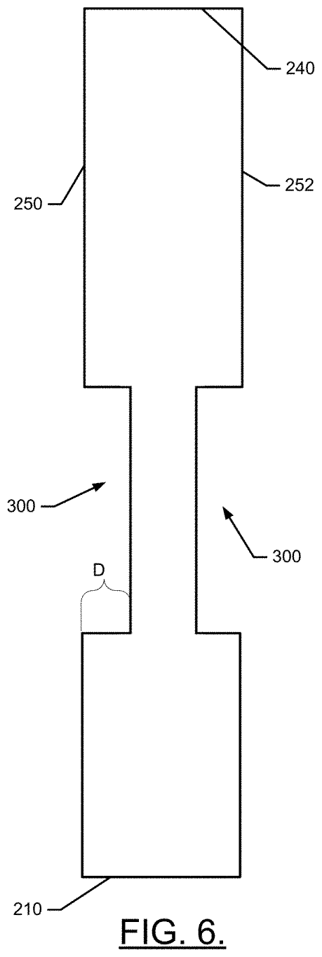

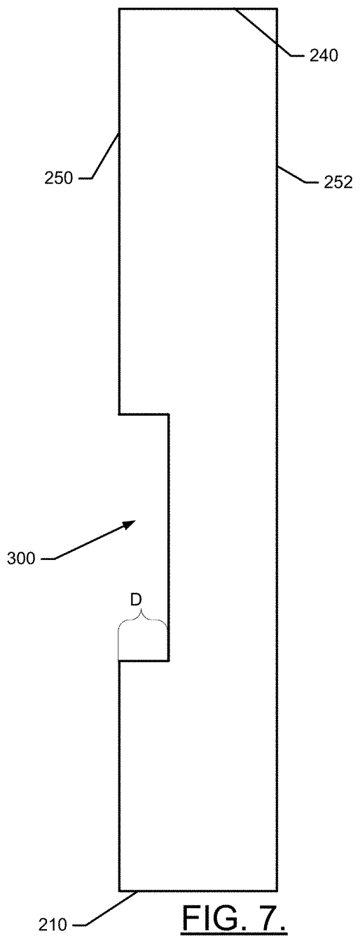

A depth of the slots 300 may extend from the first side face 250 toward second side face 252 (see FIG. 5) by any of a number of selected depths. In this regard, in some cases, the slots 300 may have a depth that extends fully through the blade 200′ from the first side face 250 to the second side face 252 as shown in FIG. 5. However, in other alternatives, the slots 300 may be cut to a depth (D) of as little as 0.05 mm to a maximum of a through cut. Thus, for example, the slots 300 may be formed by embossing the first side face 250 and/or the second side face 252. Thus, the depth (D) may be cut from one side (as shown in FIG. 7) or from both sides (as shown in FIG. 6).

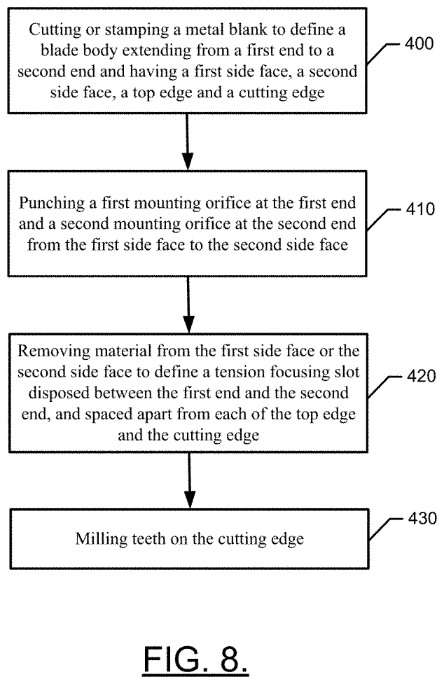

FIG. 8 illustrates a block diagram of a method of making a blade for a hacksaw in accordance with an example embodiment. The method may include cutting or stamping a metal blank to define a blade body extending from a first end to a second end and having a first side face, a second side face, a top edge and a cutting edge at operation 400. In this regard, the blank may be cut from a strip roll of carbon steel, high speed steel, or other rigid materials. The method may further include punching a first mounting orifice at the first end and a second mounting orifice at the second end from the first side face to the second side face at operation 410. In some embodiments, the method may further include removing material from the first side face or the second side face to define a tension focusing slot disposed between the first end and the second end, and spaced apart from each of the top edge and the cutting edge at operation 420, and milling teeth on the cutting edge at operation 430.

In some embodiments, the operations of the method described above may be augmented or modified, or additional features may be added. These augmentations, modifications and additions may be optional and may be provided in any combination. Thus, although some example modifications, augmentations and additions are listed below, it should be appreciated that any of the modifications, augmentations and additions could be implemented individually or in combination with one or more, or even all of the other modifications, augmentations and additions that are listed. As such, for example, removing the material from the first side face or the second side face may include punching a through hole from the first side face to the second side face to form the slot. In an example embodiment, the punching of the first mounting orifice and the second mounting orifice may accomplished simultaneously with punching the through hole. In some embodiments, punching the through hole may include punching a plurality of through holes to form a plurality of slots aligned with each other and disposed such that each of the slots is equidistant from the cutting edge. In some cases, each of the slots may also be disposed closer to the cutting edge than to the top edge. In an example embodiment, a height of the slot is between about 3% to about 40% of a height of the blade measured between the cutting edge and the top edge.

In an example embodiment, a blade for a hacksaw may be provided. The hacksaw blade may include a first end having a first mounting orifice, a second end having a second mounting orifice, a first side face extending from the first end to the second end, and a second side face, opposite the first side face and extending from the first end to the second end. The blade may further include a top edge extending from the first end to the second end between the first and second side faces, a cutting edge disposed opposite the top edge and including cutting teeth disposed thereon, and a tension focusing slot disposed between the first end and the second end, and spaced apart from each of the top edge and the cutting edge. The slot may be formed by material removal from at least the first side face.

In some embodiments, the features of the device described above may be augmented or modified, or additional features may be added. These augmentations, modifications and additions may be optional and may be provided in any combination. Thus, although some example modifications, augmentations and additions are listed below, it should be appreciated that any of the modifications, augmentations and additions could be implemented individually or in combination with one or more, or even all of the other modifications, augmentations and additions that are listed. As such, for example, the slot may be formed by material being removed from both the first side face and the second side face. In an example embodiment, the slot may be formed by an equal amount of material being removed from each of the first side face and the second side face. In some cases, a depth of the slot may be between about 8% to 100% of a thickness of the blade measured between the first side face and the second side face. In an example embodiment, the depth of the slot may be greater than about 0.05 mm. In some cases, the slot may be a through cut passing entirely from the first side face to the second side face. In an example embodiment, a length of the slot may be between about 0.5 mm to about 100 mm. In some cases, a plurality of instances of the slot may be aligned with each other and disposed such that each of the instances of the slot is equidistant from the cutting edge. In an example embodiment, a longitudinal centerline of each of the instances of the slot may be closer to the cutting edge than the top edge. In some cases, a distance between adjacent ones of the instances of the slot may be between about 0.5 mm and about 200 mm. In an example embodiment, a number of the instances of the slot may be from two to fifty. In some cases, the slot may be offset from a longitudinal centerline of the blade in a range extending from about 5 mm above the longitudinal centerline to about 5 mm below the longitudinal centerline. In an example embodiment, the slot may extend over between about 5% to about 95% of a length of the blade. In some cases, a height of the slot may be between about 3% to about 40% of a height of the blade measured between the cutting edge and the top edge.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A hacksaw blade comprising:
a first end having a first mounting orifice;
a second end having a second mounting orifice;
a first side face extending from the first end to the second end;
a second side face, opposite the first side face and extending from the first end to the second end;
a top edge extending from the first end to the second end between the first and second side faces;
a cutting edge disposed opposite the top edge and including cutting teeth disposed thereon; and
a tension focusing slot disposed between the first end and the second end, and spaced apart from each of the top edge and the cutting edge, the slot comprising material removed from at least the first side face.

2. The blade of claim 1, wherein the slot comprises material removed from both the first side face and the second side face.

3. The blade of claim 2, wherein the slot comprises an equal amount of material removed from each of the first side face and the second side face.

4. The blade of claim 2, wherein a depth of the slot is between about 8% to 100% of a thickness of the blade measured between the first side face and the second side face.

5. The blade of claim 4, wherein the depth of the slot is greater than about 0.05 mm.

6. The blade of claim 1, wherein the slot is a through cut passing entirely from the first side face to the second side face.

7. The blade of claim 1, wherein a length of the slot is between about 0.5 mm to about 100 mm.

8. The blade of claim 7, wherein a plurality of instances of the slot are aligned with each other and disposed such that each of the instances of the slot is equidistant from the cutting edge.

9. The blade of claim 8, wherein a longitudinal centerline of each of the instances of the slot is closer to the cutting edge than the top edge.

10. The blade of claim 8, wherein a distance between adjacent ones of the instances of the slot is between about 0.5 mm and about 200 mm.

11. The blade of claim 8, wherein a number of the instances of the slot is from two to fifty.

12. The blade of claim 1, wherein the slot is offset from a longitudinal centerline of the blade in a range extending from about 5 mm above the longitudinal centerline to about 5 mm below the longitudinal centerline.

13. The blade of claim 1, wherein the slot extends over between about 5% to about 95% of a length of the blade.

14. The blade of claim 1, wherein a height of the slot is between about 3% to about 40% of a height of the blade measured between the cutting edge and the top edge.

15. A method of making a blade for a hacksaw, the method comprising:
cutting or stamping a metal blank to define a blade body extending from a first end to a second end and having a first side face, a second side face, a top edge and a cutting edge;
punching a first mounting orifice at the first end and a second mounting orifice at the second end from the first side face to the second side face;
removing material from the first side face or the second side face to define a tension focusing slot disposed between the first end and the second end, and spaced apart from each of the top edge and the cutting edge; and
milling teeth on the cutting edge.

16. The method of claim 15, wherein removing the material from the first side face or the second side face comprises punching a through hole from the first side face to the second side face to form the slot.

17. The method of claim 16, wherein the punching the first mounting orifice and the second mounting orifice is accomplished simultaneously with punching the through hole.

18. The method of claim 16, wherein punching the through hole comprises punching a plurality of through holes to form a plurality of slots aligned with each other and disposed such that each of the slots is equidistant from the cutting edge.

19. The method of claim 18, wherein each of the slots is also disposed closer to the cutting edge than to the top edge.

20. The method of claim 15, wherein a height of the slot is between about 3% to about 40% of a height of the blade measured between the cutting edge and the top edge.
